(19) United States
(12) Patent Application Publication
(10) Pub. No.: US 2017/0293020 A1
(43) Pub. Date: Oct. 12, 2017

(54) SCANNING DEVICE AND OPERATING METHOD THEREOF

(71) Applicant: Electronics and Telecommunications Research Institute, Daejeon (KR)

(72) Inventors: Min Hyup SONG, Daejeon (KR); Bong Ki MHEEN, Daejeon (KR); Hong-Seok SEO, Daejeon (KR); Gyu Dong CHOI, Daejeon (KR)

(73) Assignee: Electronics and Telecommunications Research Institute, Daejeon (KR)

(21) Appl. No.: 15/477,133

(22) Filed: Apr. 3, 2017

(30) Foreign Application Priority Data
Apr. 11, 2016 (KR) 10-2016-0044273

(51) Int. Cl. G01S 7/484; G01S 17/02; G01S 7/48; G01S 7/486; G01S 7/481

(52) U.S. Cl. CPC G01S 7/484; G01S 7/4865; G01S 7/4811; G01S 7/4806; G01S 17/026; G01S 17/936

(57) ABSTRACT

Provided is a scanning device including a transmission module configured to divide a scan target into a plurality of scan areas and alternately irradiate a first laser light and a second laser light to the scan areas that are sequentially arranged, a reception module configured to receive laser lights reflected from each of the scan areas, and an image generation module configured to generate divided images of each of the scan areas by using the reflected laser lights and generate a whole image of the scan target based on the divided images and an edge component of the reflected laser lights, wherein the transmission module is configured to trigger a rising edge of a trigger signal to generate the first laser light and trigger a falling edge of the trigger signal to generate the second laser light.

### CROSS-REFERENCE TO RELATED APPLICATIONS

This U.S. non-provisional patent application claims priority under 35 U.S.C. §119 of Korean Patent Application No. 10-2016-0044273, filed on Apr. 11, 2016, the entire contents of which are hereby incorporated by reference.

### BACKGROUND

The present disclosure herein relates to a scanning device and an operating method thereof.

A method of obtaining a 3D image at a high speed is a factor necessary for a field that needs quick and accurate object recognition and operation control. A 3D image sensor that may obtain a 3D image at a high speed may be utilized in various fields, such as a machine, robot, vehicle, vehicle industry, and game/education content industry, and especially, it is predicted that most industries that need an unmanned technology and automation will have high utilization.

A technique of 3-dimensionally recognizing a space may be divided into an active mode in which light is irradiated and a passive mode depending on whether to use a light source, and it is a modern trend that the active mode is more preferred than the passive mode. The active mode is based on a time-of-flight (TOF) technique which uses a difference in time between when light energy having a specific pattern is irradiated to a subject and when the light energy is returned from the subject through reflection.

Especially, the TOF technique may use a pulse or modulated continuous-wave light source as the light energy, and may calculate a time for which the light energy is reflected from the subject and calculate the distance between the light source and the subject to recognize a space. The TOF technique has high resolution and is useful for measuring a 3D image of a subject that is disposed at a long distance.

### SUMMARY

The present disclosure provides a scanning device that alternately irradiates a first laser light including a rising edge component of a laser light and a second laser light including a falling edge component to a plurality of scan areas sequentially arranged, and uses divided images generated based on a first reflected laser light and a second reflected laser light, respectively to generate a whole image of a scan target, and an operating method of the scanning device.

An embodiment of the inventive concept provides a scanning device including a transmission module configured to divide a scan target into a plurality of scan areas and alternately irradiate a first laser light and a second laser light to the scan areas that are sequentially arranged; a reception module configured to receive laser lights reflected from each of the scan areas; and an image generation module configured to generate divided images of each of the scan areas by using the reflected laser lights and generate a whole image of the scan target based on the divided images and an edge component of the reflected laser lights, wherein the transmission module is configured to trigger a rising edge of a trigger signal to generate the first laser light and trigger a falling edge of the trigger signal to generate the second laser light.

In an embodiment, the scanning device may further include a beam splitter configured to split the first laser light irradiated along a first direction in the first direction and a second direction and split the second laser light irradiated along a third direction in the third direction and a fourth direction.

In an embodiment, the first direction and the second direction may make an angle of about 90°.

In an embodiment, the third direction and the fourth direction may make an angle of about 90°.

In an embodiment, the first direction and the second direction may make an acute angle.

In an embodiment, the third direction and the fourth direction may make an acute angle.

In an embodiment, the reception module may include a first light receiving unit configured to receive a first laser light reflected from the first direction; a second light receiving unit configured to receive a first laser light reflected from the second direction; a third light receiving unit configured to receive a second laser light reflected from the third direction; and a fourth light receiving unit configured to receive a second laser light reflected from the fourth direction.

In an embodiment, the beam splitter may be configured to split the first laser light and the second laser light in 360° all directions.

In an embodiment, the whole image may be a 3D image.

In an embodiment of the inventive concept, an operating method of a scanning device includes dividing a scan target into a plurality of scan areas; alternately irradiating a first laser light and a second laser light to the scan areas that are sequentially arranged; splitting the first laser light irradiated along a first direction in the first direction and a second direction; splitting the second laser light irradiated along a third direction into the third direction and a fourth direction; receiving the first laser light reflected from each of the first direction and the second direction to generate first divided images; receiving the second laser light reflected from each of the third direction and the fourth direction to generate second divided images; and generating a whole image of the scan target based on the first divided images and the second divided images, wherein each of the first laser light and the second laser light is generated by triggering of laser pulses having different heights.

In an embodiment, the first laser light may include a rising edge of the laser pulse, and the second laser light may include a falling edge of the laser pulse.

In an embodiment, the first direction and the second direction may make an angle of about 90°.

In an embodiment, the third direction and the fourth direction may make an angle of about 90°.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a block diagram of a scanning device according to an embodiment of the inventive concept;

FIG. 2 is a conceptual view for describing an operating method of the scanning device according to an embodiment of the inventive concept;

FIG. 3A is a conceptual view for describing how the scanning device irradiates a first laser light to a first scan area, according to an embodiment of the inventive concept;

FIG. 3B is a conceptual view for describing how the scanning device irradiates a second laser light to a second scan area, according to an embodiment of the inventive concept;

FIG. 3C is a conceptual view for describing how the scanning device alternately irradiates the first laser light and the second laser light to scan areas, according to an embodiment of the inventive concept;

FIG. 4 is a conceptual view for describing how a beam splitter splits and irradiates a laser light, according to an embodiment of the inventive concept;

FIGS. 5A to 5D are conceptual views for describing how the scanning device is installed at a vehicle to perform a scanning operation, according to an embodiment of the inventive concept; and

FIG. 6 is a flow chart for describing an operating method of the scanning device according to an embodiment of the inventive concept.

### DETAILED DESCRIPTION

Specific structural or functional descriptions on embodiments according to the inventive concept that are disclosed in the specification are only provided for the purpose of describing embodiments according to the inventive concept, and embodiments according to the inventive concept may have various forms and are not limited to the embodiments described in the specification.

Since embodiments according to the inventive concept may make various changes and have many forms, embodiments are illustrated in the drawings and described in detail in the specification. However, inventors do not intend to limit embodiments according to the inventive concept to particular disclosed embodiments and the inventive concept covers all changes, equivalents and replacements that fall within the spirit and technical scope of the inventive concept.

Although the terms a ‘first’ and a ‘second’ may be used to describe various components, these components should not be limited by these terms. The terms are only used to distinguish one component from another component, and for example, without departing from a right scope according to the inventive concept, a first component may be named as a second component and in a similar manner, the second component may also be named as the first component.

When any component is referred to as being “connected” or “accessed” to another component, it should be understood that the former can be directly connected or accessed to the latter or that there may be another component in between. On the contrary, when any component is referred to as being “directly connected” or “directly accessed” to another component, it should be understood that there may be no other component in between. Other expressions for describing the relationship between components, e.g., “between”, “directly between”“adjacent to” or “directly adjacent to” should also be construed in the same manner

The terms used in the specification are only used in order to describe particular embodiments and are not intended to limit the inventive concept. The terms in singular form include the plural form unless otherwise specified. In the specification, it should be understood that the terms “includes” and “has” indicate the presence of characteristics, numbers, steps, operations, components, parts or combinations thereof represented in the specification and do not exclude the presence or addition of one or more other characteristics, numbers, steps, operations, components, parts or combinations thereof.

Unless otherwise defined herein, all terms used herein including technical or scientific terms have the same meanings as those generally understood by a person skilled in the art. Terms defined in generally used dictionaries should be construed to have meanings matching contextual meanings in the conventional art and should not be construed as having an ideal or excessively formal meaning unless otherwise defined herein.

A module in the specification may mean a functional or structural combination of hardware for performing a method according to an embodiment of the inventive concept or software capable of driving the hardware. Thus, the module may mean a logical unit or set of a program code and a hardware resource that may perform the program code, and does not necessarily mean a physically connected code or a single type of hardware.

In the following, embodiments of the inventive concept are described in detail with reference to the drawings attached to the specification.

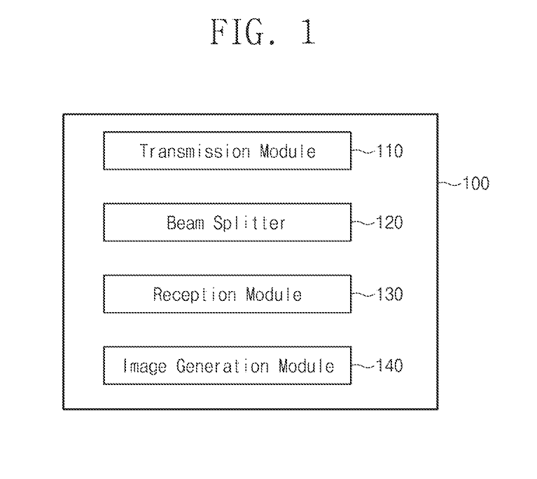

FIG. 1 is a block diagram of a scanning device according to an embodiment of the inventive concept.

Referring to FIG. 1, a scanning device 100 according to an embodiment of the inventive concept includes a transmission module 110, a beam splitter 120, a reception module 130, and an image generation module 140.

The scanning device 100 may irradiate a laser light to a scan target, and use a laser light reflected from the scan target to generate a 3D image.

According to an embodiment, the laser light may be a pulse or modulated continuous-wave light source.

According to an embodiment, the scanning device 100 may be implemented as a laser radar system that applies fixed-type integration detector based non-rotating detection system.

The scanning device 100 implemented as the laser radar system may first irradiate a laser light to a scan target, and then use a light-receiving system and a large-area light-receiving element to detect a reflected laser light. Information on the intensity and reflected time of the detected laser light may be implemented as a 3D image through a signal processing.

The scanning device 100 implemented as the laser radar system provides an advantage in obtaining a high-speed high-resolution 3D image, and changes the frame rate of the generated 3D image, the operating frequency of a pulse laser, or the like to perform a variable operation.

Also, the scanning device 100 implemented as the laser radar system may have various transceiving structures because it has no need to align the transmission module 110 irradiating light energy and the reception module 130 receiving reflected light energy in a pixel level. Thus, the scanning device 100 implemented as the laser radar system has high technical variations and applicability according to the needs of various applications.

The transmission module 110 may generate a laser light that has a rising edge or falling edge.

For example, the transmission module 110 may generate a trigger signal, trigger the rising edge of the generated trigger signal to generate a first laser light, and trigger the falling edge of the generated trigger signal to generate a second laser light.

The transmission module 110 may divide a scan target into a plurality of scan areas, and alternately irradiate the first laser light and the second laser light to the scan areas that are sequentially arranged.

The beam splitter 120 may split the laser light irradiated from the transmission module 110 in at least two directions. The scanning device 100 may include a plurality of beam splitters 120, and the laser light split from the beam splitter 120 may be re-split from another beam splitter 120 and irradiated to a scan target.

The scanning device 100 may use the plurality of beam splitters to irradiate a laser light in 360° all directions even when it uses a single transmission module 110.

The reception module 130 may receive the laser light reflected from the plurality of scan areas.

According to an embodiment, the reception module 130 may use a light-receiving system, a large-area light-receiving element, or the like to detect the reflected laser light.

The reception module 130 may include a plurality of light receiving units corresponding to directions in which the laser light is reflected.

For example, it is possible to include a first light receiving unit in order to receive a laser light reflected from a first direction, and it is possible to include a second light receiving unit in order to receive a laser light reflected from a second direction different from the first direction.

The image generation module 140 may use the reflected laser light to generate a divided image for each of scan areas. At this point, the image generation module 140 may use the reflected laser light to generate the divided image based on a time of flight (TOF) technique.

The image generation module 140 may generate a whole image for a scan target based on the divided image. The image generation module 140 may generate the whole image based on an edge component of the reflected laser lights.

The image generation module 140 may section the divided images based on the edge component of the first reflected laser light and the edge component of the second reflected laser light. For example, the first reflected laser light may comprise rising edge, and the second reflected laser light may comprise falling edge. Therefore, the image generation module 140 may clearly match the divided images to generate the whole image. At this point, the whole image may be a 3D image.

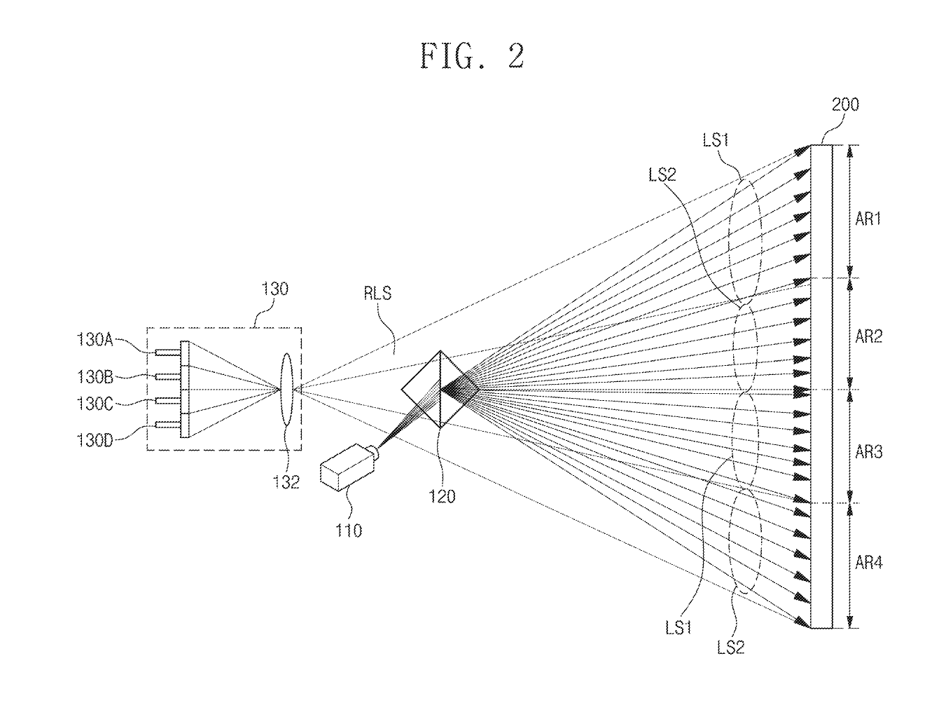

FIG. 2 is a conceptual view for describing an operating method of the scanning device according to an embodiment of the inventive concept.

FIG. 2 shows that the transmission module 110 irradiates a first laser light LS1 and a second laser light LS2 to the beam splitter 120, and it shows the first laser light LS1 and the second laser light that have been split through the beam splitter 120 and irradiated in a plurality of directions.

Here, the first laser light LS1 may mean a laser light that is generated through the triggering of the rising edge of a laser light, and the second laser light LS2 may mean a laser light that is generated through the triggering of the falling edge of a laser light.

The transmission module 110 may divide the scan target 200 into a plurality of scan areas AR1 to AR4, and irradiate the first laser light LS1 and the second laser light LS2 to each of the scan areas AR1 to AR4 through the beam splitter 120.

The reception module 130 may use an optical lens 132 and light receiving units 130A to 130D to receive the laser light reflected from the scan areas AR1 to AR4.

According to an embodiment, the light receiving units 130A to 130D may receive the laser light RLS reflected from corresponding scan areas AR1 to AR4, respectively.

For example, a first light receiving unit 130A may receive a first laser light reflected from a first scan area AR1, a second light receiving unit 130B may receive a second laser light reflected from a second scan area AR2, a third light receiving unit 130C may receive a first laser light reflected from a third scan area

AR3, and a fourth light receiving unit 130D may receive a second laser light reflected from a fourth scan area AR4.

The first reflected laser light and the second reflected laser light that are received from each of the light receiving units 130A to 130D may be generated as divided image by the image generation module 140, and the image generation module 140 may use the divided images to generate a single whole image. A difference between the first reflected laser light and the second reflected laser light may be recognized based on difference between an edge component of the first reflected laser light and an edge component of the second reflected laser light. The image generation module 140 may match the divided images to generate the whole image based on the edge components of the first and second reflected laser light.

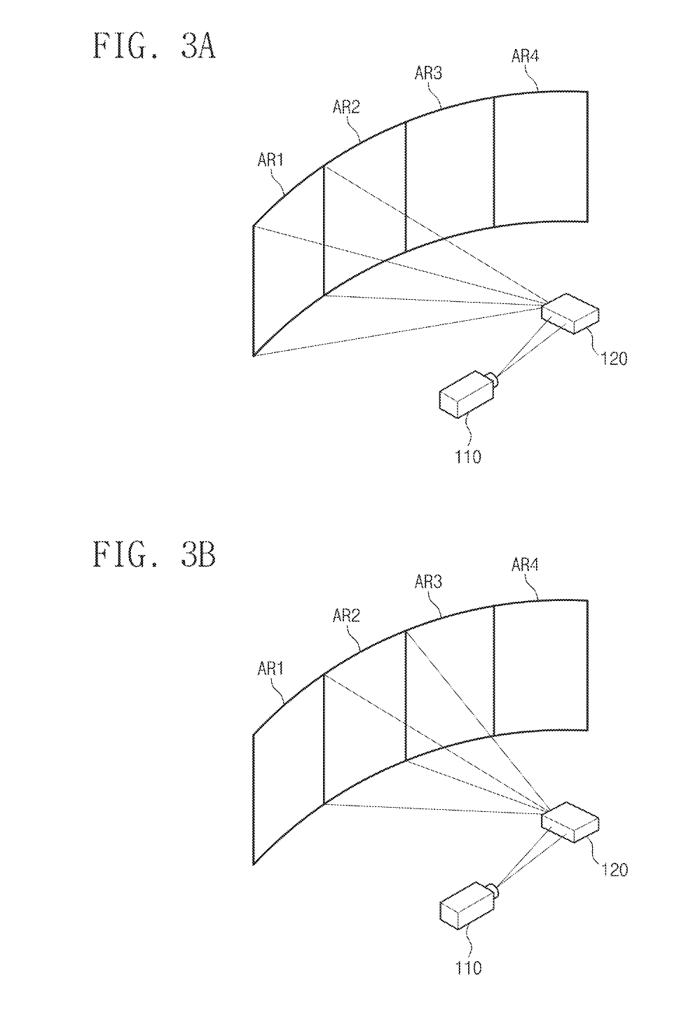

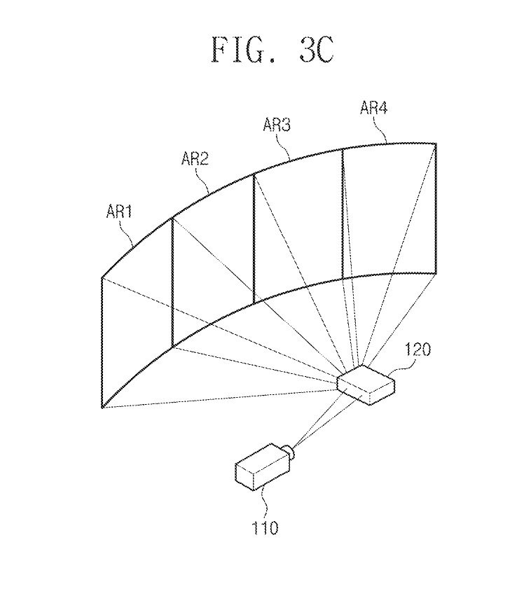

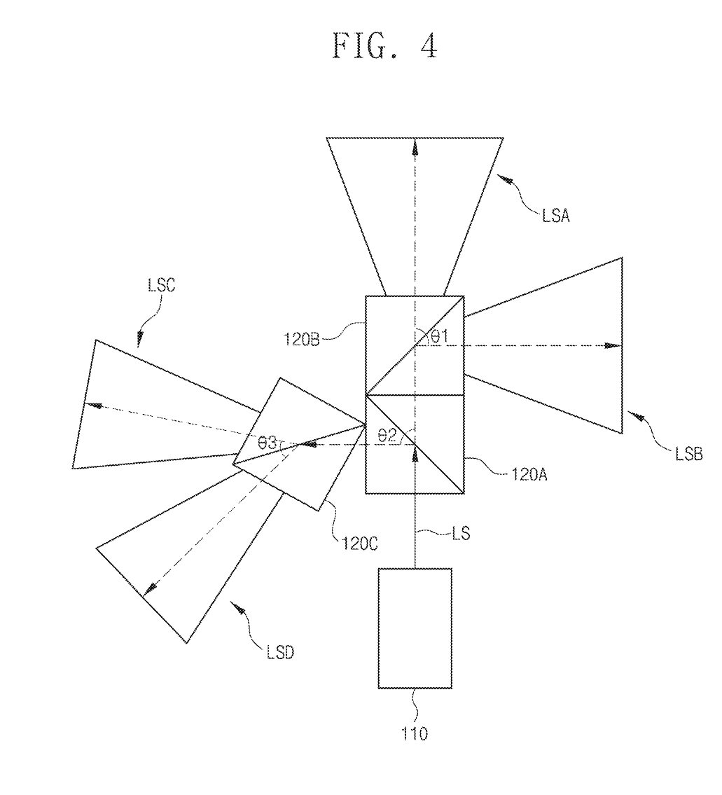

FIG. 3A is a conceptual view for describing how the scanning device irradiates the first laser light to the first scan area, according to an embodiment of the inventive concept, FIG. 3B is a conceptual view for describing how the scanning device irradiates the second laser light to the second scan area, according to an embodiment of the inventive concept, and FIG. 3C is a conceptual view for describing how the scanning device alternately irradiates the first laser light and the second laser light to scan areas, according to an embodiment of the inventive concept.

Referring to FIG. 3A, the transmission module 110 may irradiate the first laser light LS1 including the rising edge or the second laser light LS2 including the falling edge to the first scan area AR1, through the beam splitter 120.

At this point, the first scan area AR1 may receive the first laser light LS1 or the second laser light LS2 because the transmission module 110 may irradiate a single type of laser light to the scan area at the same time.

Referring to FIG. 3B, the transmission module 110 may irradiate the first laser light LS1 including the rising edge or the second laser light LS2 including the falling edge to the second scan area AR2, through the beam splitter 120.

At this point, the transmission module 110 irradiates the second laser light LS2 to the second scan area AR2 in a case where the transmission module 110 irradiates the first laser light LS1 to the first scan area AR1. In addition, the transmission module 110 irradiates the first laser light LS1 to the second scan area AR2 in a case where the transmission module 110 irradiates the second laser light LS2 to the first scan area AR1.

That is, the transmission module 110 may irradiate laser lights having different pulse heights to the scan areas AR1 to AR4.

FIG. 3C shows how the transmission module 110 irradiates the first laser light LS1 or the second laser light LS2 to the scan areas AR1 to AR4.

The transmission module 110 alternately irradiates the first laser light LS1 or the second laser light LS2 to the scan areas AR1 to AR4 that are sequentially arranged.

When e.g., the transmission module 110 irradiates the first laser light LS1 to the first scan area AR1, the transmission module 110 irradiates the second laser light LS2 to the second scan area AR2, the first laser light LS1 to the third scan area AR3, and the second laser light LS2 to the fourth scan area AR4.

When the transmission module 110 consecutively irradiates the first laser light LS1 or the second laser light LS2 to the scan areas AR1 to AR4 that are sequentially arranged, a divided image generated by using the laser lights reflected from the scan areas AR1 to AR4 may include an interference image.

Thus, the transmission module 110 may alternately irradiate the first laser light LS1 and the second laser light LS2 to the scan areas AR1 to AR4 that are sequentially arranged, to minimize an interference phenomenon by the laser light reflected from an adjacent scan area.

That is, the image generation module 140 may compose a first divided image to a fourth divided image to generate a whole image including a minimum interference image in a case where the image generation module 140 uses the first laser light LS1 reflected from the first scan area AR1 to generate the first divided image, the second laser light LS2 reflected from the second scan area AR2 to generate a second divided image, the first laser light LS1 reflected from the third scan area AR3 to generate a third divided image, and the second laser light LS2 reflected from the fourth scan area AR4 to generate the fourth divided image.

Although for the convenience of description of the inventive concept, these figures show that the transmission module 110 irradiates the first laser light LS1 first and irradiates the second laser light LS2 subsequently, the embodiment is not limited thereto and the transmission module 110 may irradiate the second laser light LS2 first and irradiate the first laser light LS1 subsequently.

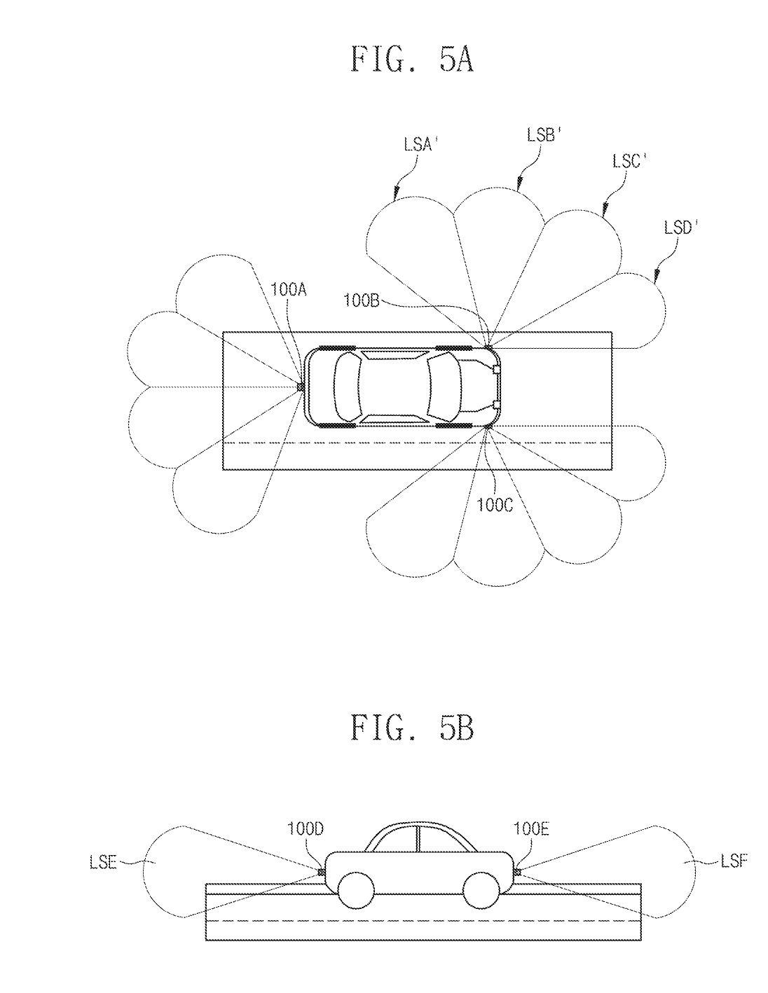

FIG. 4 is a conceptual view for describing how the beam splitter splits a laser light, according to an embodiment of the inventive concept.

Referring to FIG. 4, the scanning device 100 may include a plurality of beam splitters 120A to 120C along the location of scan areas to which a laser light LS is irradiated.

Each of the beam splitters 120A to 120C may split an incident laser light LS in a plurality of directions.

A first beam splitter 120A may split a laser light entering along a first direction from the transmission module 110 into the first direction and a second direction. The laser light split into the first direction by the first beam splitter 120A enters a second beam splitter 120B, and the laser light split into the second direction enters a third beam splitter 120C.

According to an embodiment, when an angle that the first direction and the reflecting surface of the first beam splitter 120A make is about 45°, an angle 02 that the laser light split into the first direction by the first beam splitter 120A and the laser light split into the second direction make may be about 90°.

The second beam splitter 120B may split a laser light entering from the first beam splitter 120A along the first direction into the first direction and a third direction.

The laser light LSA split into the first direction by the second beam splitter 120B is irradiated to a scan area located at the first direction, and the laser light split into the third direction is irradiated to a scan area located at the third direction.

According to an embodiment, when an angle that the first direction and the reflecting surface of the second beam splitter 120B make is about 45°, an angle θ1 that the laser light LSA split into the first direction by the second beam splitter 120B and the laser light LSB split into the third direction make may be about 90°.

The third beam splitter 120C may split a laser light entering from the first beam splitter 120A along the second direction into a fourth direction and a fifth direction.

The laser light LSC split into the fourth direction by the third beam splitter 120C is irradiated to a scan area located at the fourth direction, and the laser light LSD split into the fifth direction is irradiated to a scan area located at the fifth direction.

According to an embodiment, when an angle that the second direction and the reflecting surface of the third beam splitter 120C make is smaller than 45°, an angle θ3 that the laser light LSC split into the fourth direction by the third beam splitter 120C and the laser light LSD split into the fifth direction make may be an acute angle.

As such, the scanning device 100 may adjust an angle made by the reflecting surface of each of the beam splitters 120A to 120C to adjust the irradiation direction of a laser light.

Thus, the scanning device 100 may adjust an angle made by the reflecting surfaces of the beam splitters 120A to 120C to irradiate the laser light entering from the transmission module 110 in 360° all directions.

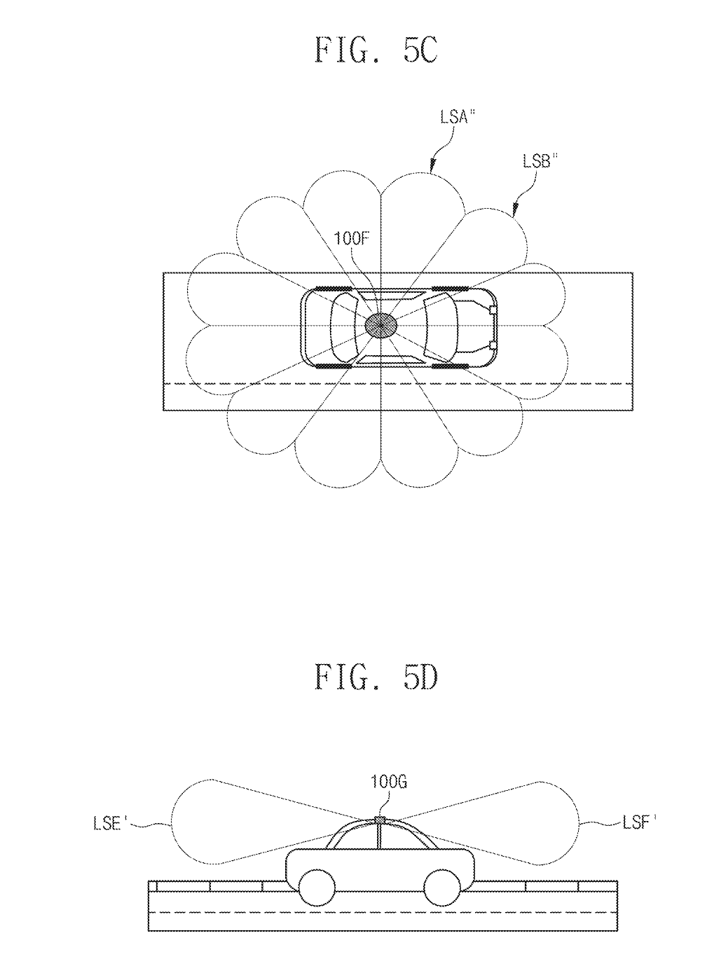

FIGS. 5A to 5D are conceptual views for describing how the scanning device is installed at a vehicle to perform a scanning operation, according to an embodiment of the inventive concept.

Referring to FIG. 5A, scanning devices 100A to 100C according to an embodiment may be installed at the rear side, front left side, and front right side of a vehicle to perform a scanning operation.

The scanning device 100A installed at the rear side of the vehicle may scan scan areas arranged at the rear side, the scanning device 100B installed at the front left side may scan scan areas arranged at the left and front sides, and the scanning device 100C installed at the front right side may scan scan areas arranged at the right and front sides.

At this point, each of the scanning devices 100A to 100C may alternately irradiate a first laser light including a rising edge and a second laser light including a falling edge to sequentially arranged scan areas.

For example, the scanning device 100B arranged at the front left side may irradiate, to scan areas sequentially arranged at the left and front sides, a first laser light LSA' in a first direction, a second laser light LSB' in a second direction, a first laser light LSC' in a third direction, and a second laser light LSD' in a fourth direction.

Referring to FIG. 5B, a scanning device according to an embodiment may be installed at the rear and front sides of a vehicle to perform a scanning operation. Since the operating method of scanning devices 100D and 100E shown in FIG. 5B is substantially the same as that of the scanning devices 100A to 100C shown in FIG. 5A, repetitive descriptions are omitted.

The scanning device 100D installed at the rear side of the vehicle may scan scan areas arranged at the rear side, and the scanning device 100E installed at the front left side may scan scan areas arranged at the front side.

Referring to FIGS. 5C and 5D, a scanning device according to an embodiment may be installed at the top end of a vehicle, e.g., roof, to perform a scanning operation. Since the operating method of scanning devices 100F and 100G shown in FIGS. 5C and 5D is substantially the same as that of the scanning devices 100A to 100C shown in FIG. 5A, repetitive descriptions are omitted.

The scanning device 100F installed at the top end of the vehicle may scan scan areas arranged in all directions. At this point, the scanning devices 100F installed at the top end of the vehicle may alternately irradiate a first laser light including a rising edge and a second laser light including a falling edge to sequentially arranged scan areas.

For example, the scanning device 100F installed at the top end of the vehicle may irradiate, to scan areas sequentially arranged in all directions, a first laser light LSA″ in a first direction and a second laser light LSB″ in a second direction.

According to an embodiment, the scanning device 100G installed at the top end of the vehicle may scan scan areas arranged at only the front and rear sides.

As such, the scanning devices according to embodiments of the inventive concept may irradiate a laser light arbitrarily according to the location of a scan area to perform a scanning operation.

The operating methods of the scanning devices included in the vehicle that have been described in FIGS. 5A to 5D are for the convenience of descriptions of the inventive concept, so the embodiment is not limited thereto and the scanning device according to an embodiment of the inventive concept may be included in many transportation means, e.g., airplanes, motor bicycles, or bicycles to perform a scanning operation.

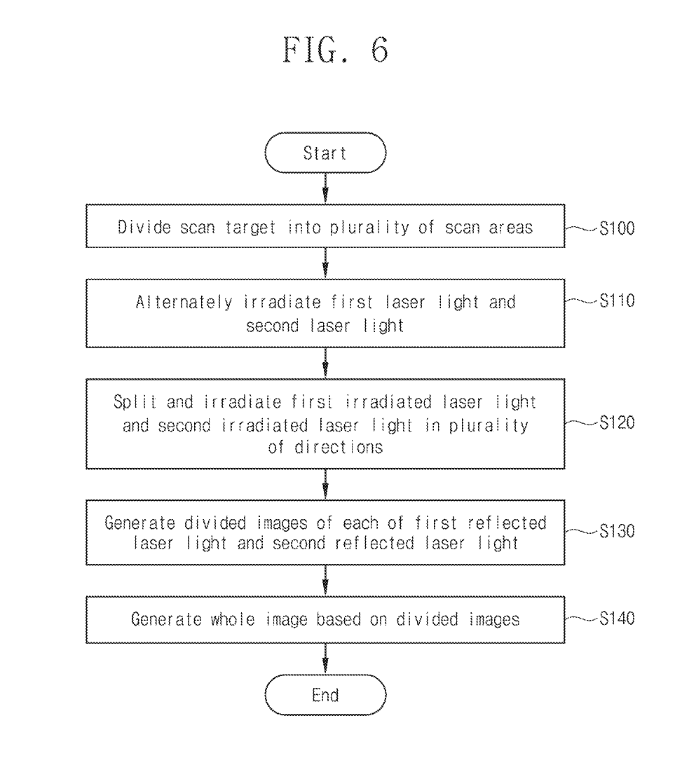

FIG. 6 is a flow chart for describing an operating method of the scanning device according to an embodiment of the inventive concept.

Referring to FIGS. 1, 2 and 6, the scanning device 100 of the inventive concept may divide a scan target into a plurality of scan areas in step S100, and alternately irradiate the first laser light LS1 and the second laser light LS2 to sequentially arranged scan areas in step S110.

At this point, the scanning device 100 may split and irradiate the first irradiated laser light LS1 and the second irradiated laser light LS2 in a plurality of directions in step S120.

The scanning device 100 may receive the first laser light LS1 and the second laser light LS2 reflected from each of the scan areas and generate divided images thereof in step S130.

The scanning device 100 may generate a whole image including a minimum interference image based on the divided images in step S140.

According to the scanning device and the operating method thereof, it is possible to alternately irradiate the first laser light including a rising edge component of a laser light and the second laser light including a falling edge component to a plurality of scan areas sequentially arranged, and use divided images generated based on each of the first laser light and the second laser light reflected from the plurality of scan areas to generate a whole image of a scan target.

According to the scanning device and the operating method thereof, it is possible to scan a scan target more clearly because it is possible to remove an interference effect occurring when generating the whole image of the scan target by using divided images. According to the scanning device and the operating method thereof, it is possible to match the divided images more clearly because it is possible to section the divided images based on the first reflected laser light including a rising edge component and the second reflected laser light including a falling edge component.

The inventive concept has been described with reference to the embodiments shown in the drawings, but a person skilled in the art would understand that the embodiments are only examples and it is possible to implement various variations and other equivalent embodiments from the inventive concept. Thus, the true technical protective scope of the inventive concept would be defined by the technical spirit of the following claims.

What is claimed is:

1. A scanning device comprising:
a transmission module configured to divide a scan target into a plurality of scan areas and alternately irradiate a first laser light and a second laser light to the scan areas that are sequentially arranged;
a reception module configured to receive laser lights reflected from each of the scan areas; and
an image generation module configured to generate divided images of each of the scan areas by using the reflected laser lights and generate a whole image of the scan target based on the divided images and an edge component of the reflected laser lights.

2. The scanning device of claim 1, wherein the transmission module is configured to trigger a rising edge of a trigger signal to generate the first laser light and trigger a falling edge of the trigger signal to generate the second laser light.

3. The scanning device of claim 2, further comprising a beam splitter configured to split the first laser light irradiated along a first direction in the first direction and a second direction and split the second laser light irradiated along a third direction in the third direction and a fourth direction.

4. The scanning device of claim 3, wherein the first direction and the second direction make an angle of about 90°.

5. The scanning device of claim 3, wherein the third direction and the fourth direction make an angle of about 90°.

6. The scanning device of claim 3, wherein the first direction and the second direction make an acute angle.

7. The scanning device of claim 3, wherein the third direction and the fourth direction make an acute angle.

8. The scanning device of claim 3, wherein the reception module comprises:
a first light receiving unit configured to receive a first laser light reflected from the first direction;
a second light receiving unit configured to receive a first laser light reflected from the second direction;
a third light receiving unit configured to receive a second laser light reflected from the third direction; and
a fourth light receiving unit configured to receive a second laser light reflected from the fourth direction.

9. The scanning device of claim 3, wherein the beam splitter is configured to split the first laser light and the second laser light in 360° all directions.

10. The scanning device of claim 1, wherein the whole image is a 3D image.

11. An operating method of a scanning device, the operating method comprising:
dividing a scan target into a plurality of scan areas;
alternately irradiating a first laser light and a second laser light to the scan areas that are sequentially arranged;
splitting the first laser light irradiated along a first direction in the first direction and a second direction;
splitting the second laser light irradiated along a third direction into the third direction and a fourth direction;
receiving the first laser light reflected from each of the first direction and the second direction to generate first divided images;
receiving the second laser light reflected from each of the third direction and the fourth direction to generate second divided images; and
generating a whole image of the scan target based on the first divided images and the second divided images,
wherein each of the first laser light and the second laser light is generated by triggering of laser pulses having different heights.

12. The operating method of claim 11, wherein the first laser light comprises a rising edge of the laser pulse, and the second laser light comprises a falling edge of the laser pulse.

13. The operating method of claim 11, wherein the first direction and the second direction make an angle of about 90°.

14. The operating method of claim 11, wherein the third direction and the fourth direction make an angle of about 90°.
